(19) United States
(12) Patent Application Publication
(10) Pub. No.: US 2005/0044570 A1
(43) Pub. Date: Feb. 24, 2005

(54) Caching data from multiple channels simultaneously

(76) Inventor: Thomas Poslinski, San Diego, CA (US)

Correspondence Address: WAGNER, MURABITO & HAO LLP, Third Floor, Two North Market Street, San Jose, CA, 95113, US

(21) Appl. No.: 10/645,790

(22) Filed: Aug. 20, 2003

(51) Int. Cl. H04N 7/173; G06F 13/00; H04N 5/445; G06F 3/00

(52) U.S. Cl. 725/48; 725/46; 725/44; 725/50; 725/134

(57) ABSTRACT

Methods and systems for caching data from multiple channels simultaneously. Data specifying a set of channels and a prioritization of the set of channels is received. Channels from the set of channels are selected for which to assign tuners to and then cache data based on the prioritization. Data for the selected channels is cached simultaneously. The tuners may be within a set-top-box. Trick modes may be used to view portions of programs represented by the cached data.

### BACKGROUND OF THE INVENTION

1. Field of The Invention

Embodiments of the present invention relate to caching data. More specifically, embodiments of the present invention relate to using set-top box devices, such as Personal Video Recorders or Digital Video Recorders for instance, to cache data from multiple channels simultaneously.

2. Related Art

Frequently while people are watching and/or recording programs on television, they want to watch portions of the programs again (also known as “viewing”). For example, they may want to use trick modes such as rewinding to re-watch portions of the programs, as well as pausing and even fast-forwarding through portions of the programs. Typically, set-top box devices, such as Personal Video Recorders or Digital Video Recorders for instance, provide mechanisms for rewinding, pausing, and/or fast-forwarding through portions of programs.

One technique used to allow people to re-watch portions of programs is to cache programs. Frequently, a specified amount (also known as a “window”) of the program is cached. Typically the window may be defined in terms of a time interval. For example, the window may be a 30 minute time interval. When a person switches to a channel, a new file (also known as a “buffer”) may be created on a caching device. Data representing the program is stored in the buffer as the data is received (also known as “live data”) from a tuner until 30 minutes of data is received.

In one implementation of a circular buffer, when 30 minutes of data has been stored in the circular buffer, the most recently received data may be stored over the oldest data stored in the circular buffer. For example, a person may start watching a program X from a channel C at time T1. At time T1, a buffer may be allocated in a caching device and data representing program X may start to be cached in the buffer. At time T1+5 minutes, 5 minutes of data is stored in the buffer. At time T1+30 minutes, the buffer is filled with data. At one second past time T1+30 minutes, the most recently received data may be stored over the data that was received at time T1. In another implementation of a circular buffer, at one second past time T1+30 minutes, the old data is deleted while new data is appended to the buffer.

Over time, people have wanted more and more capabilities from their set-top box devices. For example, users want the ability to watch multiple programs simultaneously. To meet this demand, set-top box devices with multiple tuners have been provided. For example, the multiple tuners may be assigned to receive programs for multiple channels and display them in a picture-in-picture format.

However, currently set-top box devices only allow people to utilize trick modes on the one channel they watch on their main screen. For example, a person may be watching a program X at time T1 that is being broadcast over the channel shown in the main screen. If a portion of the program X has been cached, the person may re-wind, pause, and fast-forward through the cached portion. Each time the person switches channels to watch different programs on the main screen, the cached portion of the program they switch from is de-allocated. For example, if a person switches from the channel broadcasting program X, the cached portion of program X is de-allocated. If the person requests to watch program X again at time T2, caching of program X re-starts at time T2, thus, a person cannot re-watch portions of programs from more than one channel simultaneously.

### SUMMARY OF THE INVENTION

For these and other reasons, a method and/or a system that allows people to re-watch portions of programs from multiple channels simultaneously is desirable.

Accordingly, embodiments of the present invention provide caching data from multiple channels simultaneously. Embodiments of the present invention pertain to methods and systems for caching data from multiple channels simultaneously in a digital video environment. In one embodiment, data specifying a set of channels and a prioritization of the set of channels is received. Channels from the set of channels are selected for which to cache data based on the prioritization. Digital video data for the selected channels is cached simultaneously thereby allowing trick modes for all of these channels.

In one embodiment, the system may be implemented as a set-top box device. In this embodiment, the set-top box device contains multiple tuners that can be assigned a list of channels for obtaining the digital data to be stored.

In one embodiment, the set of channels are the favorite channels of the people watching a television device that is connected to the set-top box device. In another embodiment, the multiple tuners of the set-top box can be used for picture-in-picture features.

In one embodiment, trick modes can be used to view the cached data.

In one embodiment, data that is being cached is not de-allocated when a user switches from one channel for which data is being cached to another channel for which data is also being cached.

In one embodiment, the data cached for one channel is de-allocated when a user switches from one channel for which data is being cached to a channel for which data is not being cached.

In one embodiment, caching capabilities are reassigned to the favorite channel with the highest priority of the favorite channels for which data is not being cached.

In one embodiment, caching capabilities are removed from the favorite channel with the lowest priority of the favorite channels for which data is being cached.

In one embodiment of the present invention, a Personal Video Recorder (PVR) enabled set-top box with multiple tuners and a favorite's channel list can assign spare tuners to record live cache data of video programs currently being aired on the favorite's channels. A spare tuner is defined as a tuner that is not being currently used for recording of content or for live caching of a picture-in-picture video source. The favorite's channel list is a list of channels that a user defines as being channels that are viewed on a regular basis. The user experience is enhanced by caching a typically 30-minutes or any window size of data associated with each favorite's channel up to the number of available tuners. So a user can change channels to a favorite's channel and up to the last 30-minutes of content shall be accessible by the user, allowing for rewind to the beginning of a video program if the beginning is in the 30-minute window. With a large set of tuners, the PVR enabled set-top box may be able to record multiple live caches.

A favorite's list application can be used to build and store a user's favorite's list. Associated with the favorite's list can be an option to enable live caching of favorite's channels and an assignment of priority for each entry in the favorite's list. The priority signifies which order the channels in the favorite's list are assigned to any free tuners in the system, e.g., if a tuner should be come free, an inactive channel in the favorite's list with the highest priority can be assigned the tuner for live caching to begin. A tuner that is required for normal operation of a PVR application can be de-assigned from the favorite's channel with lowest priority that currently has a tuner. The data associated with the channel of the de-assigned tuner is deleted and not available to the user.

A favorite's list channel selection screen, typically with a favorite's list application, can be provided for the user to select a favorite's channel. If a tuner had been assigned to this favorite's channel, the live data cache becomes the current live data cache buffer and video shall start to be displayed with the current live video content. The tuner associated with the channel recording live cache data prior to the channel change to the favorite's channel is allocated to the favorite's channel pool of free tuners. The live cache buffer associated with the favorite's channel is available for access by the user using the typical PVR application trick modes of pause, rewind, and fast-forward. If the tuner associated with the channel recording live cache data prior to the channel change to the favorite's channel is from a channel on the favorite's list, the live data cache buffer shall not be deleted, but live data caching shall continue to accumulate in that buffer regardless of priority until such time that a new tuner assignment or re-arrangment occurs.

### BRIEF DESCRIPTION OF THE DRAWINGS

The accompanying drawings, which are incorporated in and form a part of this specification, illustrate embodiments of the invention and, together with the description, serve to explain the principles of the invention:

FIGS. 1A and 1B are block diagrams of exemplary systems in which embodiments of the present invention can be implemented.

FIGS. 2A and 2B depict an exemplary flowchart for caching data from multiple channels simultaneously according to embodiments of the present invention.

FIGS. 3A, 3B, and 3C are exemplary dataflow diagrams for caching data from multiple channels simultaneously according to embodiments of the present invention.

FIGS. 4A, 4B, 4C and 4D are exemplary flowcharts for caching data from multiple channels simultaneously according to embodiments of the present invention.

FIG. 5 is a block diagram of an exemplary set-top box device upon which embodiments of the present invention can be implemented.

The drawings referred to in this description should not be understood as being drawn to scale except if specifically noted.

### DETAILED DESCRIPTION OF THE INVENTION

Reference will now be made in detail to various embodiments of the invention, examples of which are illustrated in the accompanying drawings. While the invention will be described in conjunction with these embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following description of the present invention, numerous specific details are set forth in order to provide a thorough understanding of the present invention. In other instances, well-known methods, procedures, components, and circuits have not been described in detail as not to unnecessarily obscure aspects of the present invention.

### System and Functional Overviews

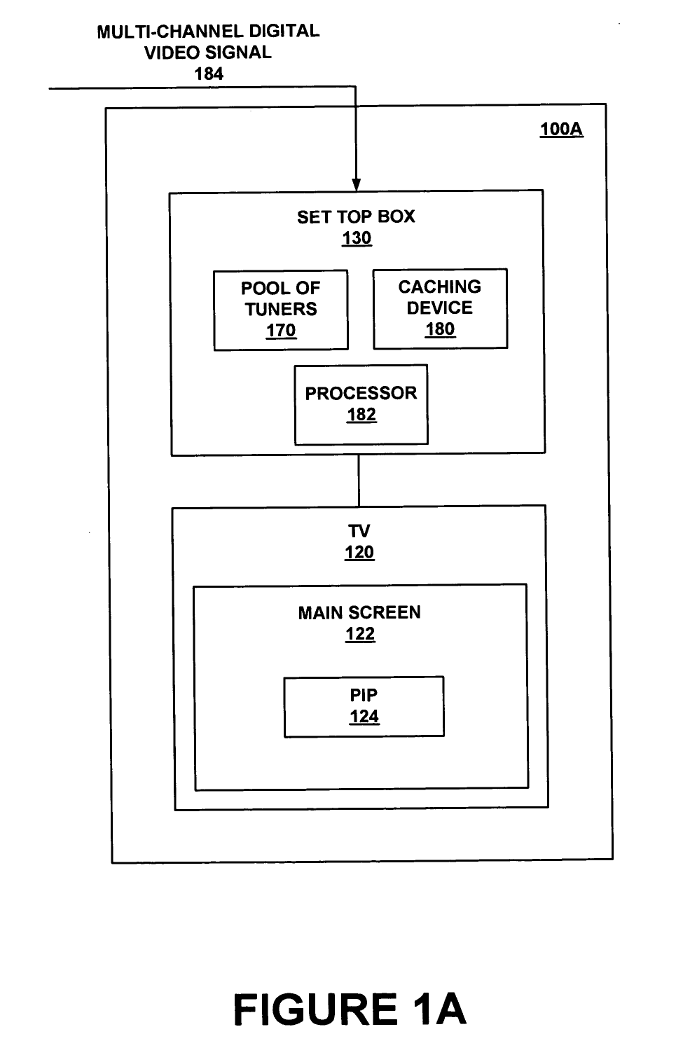

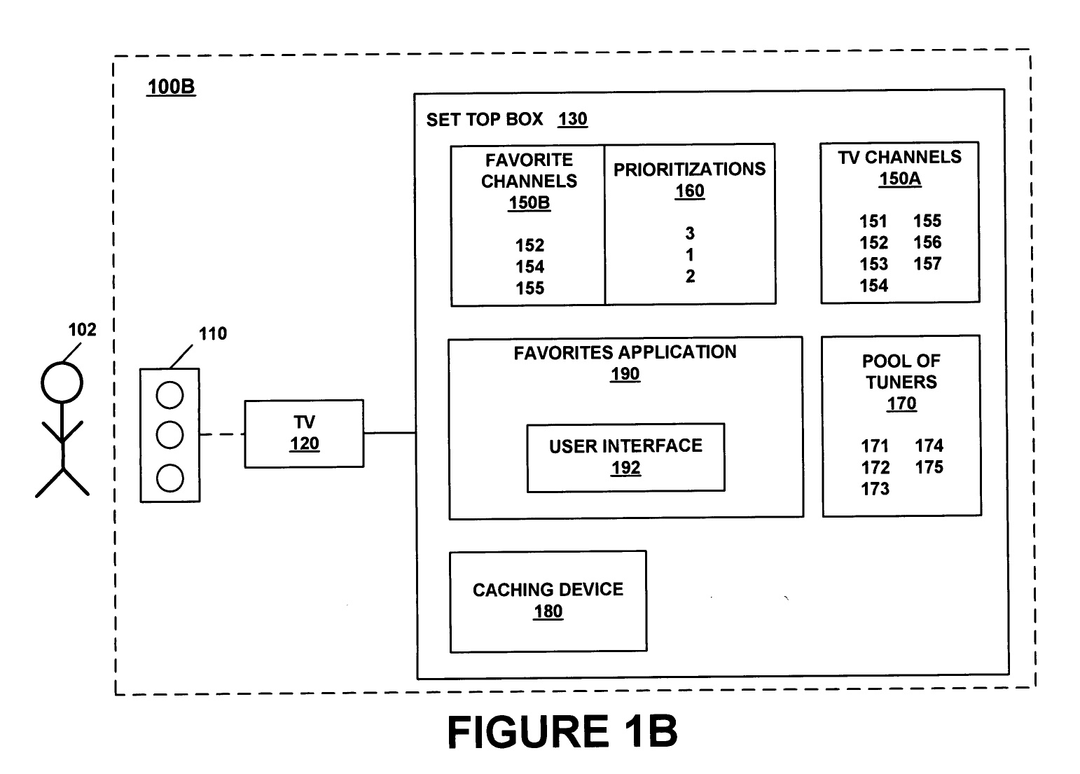

FIGS. 1A and 1B are block diagrams of exemplary systems in which embodiments of the present invention can be implemented. The blocks in FIGS. 1A and 1B can be arranged differently than as illustrated, and can implement additional features that are not described herein.

Referring to FIG. 1A, in the present embodiment, the system 100A includes a set-top box device 130 that is connected to a TV 120. In one embodiment, the box can be a PVR box. The set-top box device 130 includes, among other things, a pool of tuners 170, a caching device 180 and a processor 182. The TV 120, as depicted, displays a main screen 122 and one or more sub screens, e.g., a picture-in-picture 124 (PIP). The set-top box device 130 receives a multi-channel digital video signal 184. For example, signal 184 may include digital data for a program A and a program B that are being broadcast on two different channels. The set-top box device 130 can be connected to a TV 120 using a digital connector or interface. In one embodiment, PIP capabilities are implemented in the set-top box 130, thus, TV 120 does not need to support PIP capabilities.

If a person decides to watch a program A on the main screen 122, a tuner from the pool of tuners 170 may be assigned to the channel on which program A is broadcast. Data that represents program A may be cached in the caching device 180. Simultaneously, the person may decide to watch program B on the PIP 124. Another tuner from the pool of tuners 170 may be assigned to the channel on which program B is broadcast and data that represents program B may be simultaneously cached in the caching device 180, e.g., programs A and B may both be cached in the caching device 180. Processor 182 may execute instructions for, among other things, determining which tuners to assign to channels, and determining whether to allocate or de-allocate data cached in caching device 180. Tuners not used for main screen viewing and picture-in-picture viewing are “spare” tuners.

Referring to FIG. 1B, in the present embodiment, the system 100B may include a TV remote 110 for user 102 to request operations from TV 120. These operations may include, among other things, selecting channels to watch and/or record, requesting to re-watch portions of programs, using trick modes to re-watch portions of programs, using picture-in-picture to watch programs, etc.

As depicted, TV 120 is connected to a set-top box device 130. As depicted, set-top box device 130 includes a list of TV channels 150A, another list of channels known as the favorite channels 150B, a prioritization 160 of the favorite channels 150B, a favorites application 190 with a user interface 192, a pool of tuners 170, and a caching device 180.

In the present embodiment, the TV channels 150A corresponds to the channels that TV 120 provides to user 102 for watching and/or recording programs. For example, as depicted in FIG. 1B, TV 120 may provide channels (151, 152, 153, 154, 155, 156, and 157) to user 102, thus, TV channels 150A includes data identifying the channels (151, 152, 153, 154, 155, 156, and 157) provided by TV 120.

In the present embodiment, tuners from the pool of tuners 170 are assigned to TV channels 150A when user 102 requests to watch (e.g., main screen or PIP) and/or record programs for TV channels 150A. For example, if user 102 requests to watch a program that is being transmitted over channel 152, tuner 173 may be assigned to channel 152 allowing user 102 to watch the program.

In the present embodiment, user 102 may specify which channels of TV channels 150A are their “favorite” channels to watch and/or record from. For example, user 102 may specify that channels 152, 154, and 155 are their “favorite” channels. In the present embodiment, data designating channels 152, 154, and 155 as favorites is stored in favorite channels 150B. As described more fully below, spare tuners are assigned to the favorite channels and simultaneously caching of data is performed.

In the present embodiment, the channels of TV channels 150A, which are not designated as favorite channels 150A are “non-favorite” channels. For example, as depicted in FIG. 1B, user 102 did not designate channels 151, 153, 156, and 157 as favorites, therefore these channels are “non-favorite” channels.

Similarly, user 102 may like certain “favorite” channels more than other “favorite” channels. In the present embodiment, user 102 may specify an order or ranking in which they prefer favorite channels 150B. For example, user 102 may prefer channel 154 more than the other favorite channels 150B, channel 155 second best, and so on.

In the present embodiment, user 102 may use the user interface 192 of favorite application 160 to specify which TV channels 150A are favorite channels 150B. For example, user 102 may enter data into user interface 192 specifying that channels 152, 154, and 155 are their favorites. In the present embodiment, user 102 may enter data into the user interface 192 specifying the order in which user 102 prefers favorite channels 150B. For example, user 102 may enter a “1” indicating they like channel 154 more than any other channel, a “2” indicating they like channel 155 second most, and so on into user interface 192.

In the present embodiment, spare tuners of 170 are assigned to the list of favorite channels according to the ranking order and the output of the tuners are simultaneously cached. Caching device 180 caches portions of programs for favorite channels 150B and/or channels that are non-favorite channels that are currently being viewed. In one embodiment, portions of more than one program are cached simultaneously with caching device 180. In one embodiment, caching data from more than one channel simultaneously while recording and/or watching programs allows users to use trick modes to re-watch portions of the programs. In one embodiment, data representing a program that is being watched with picture-in-picture may be cached.

In the present embodiment, spare tuners of 170 may be assigned to non-favorite channels if programs for all of the favorite channels are being cached.

### An Operational Example of Caching Data for Multiple Channels Simultaneously

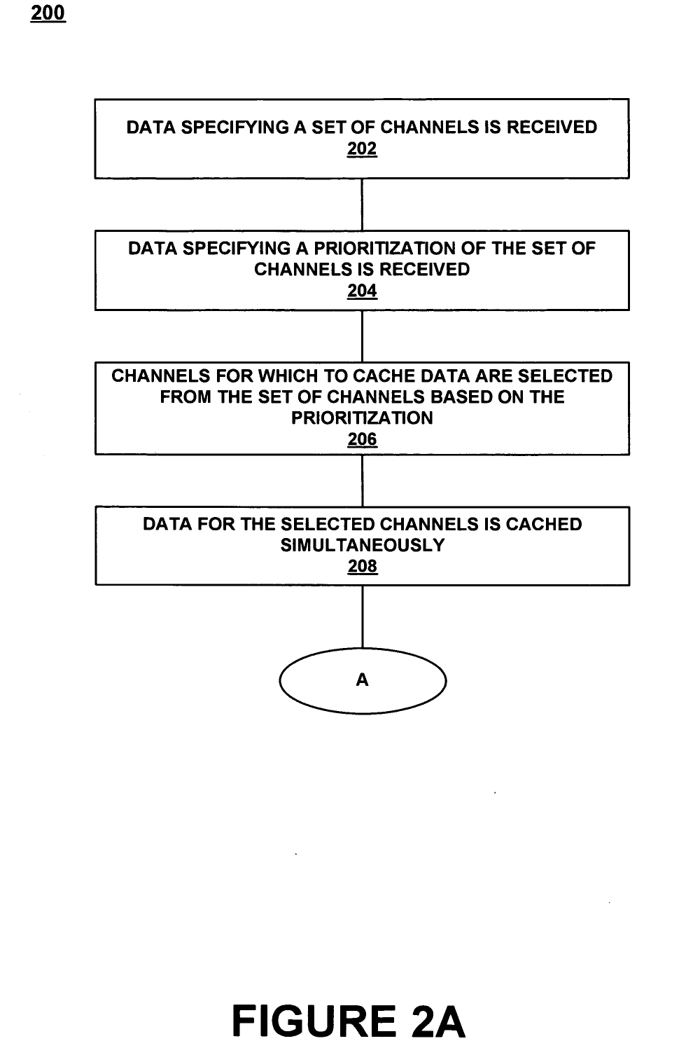

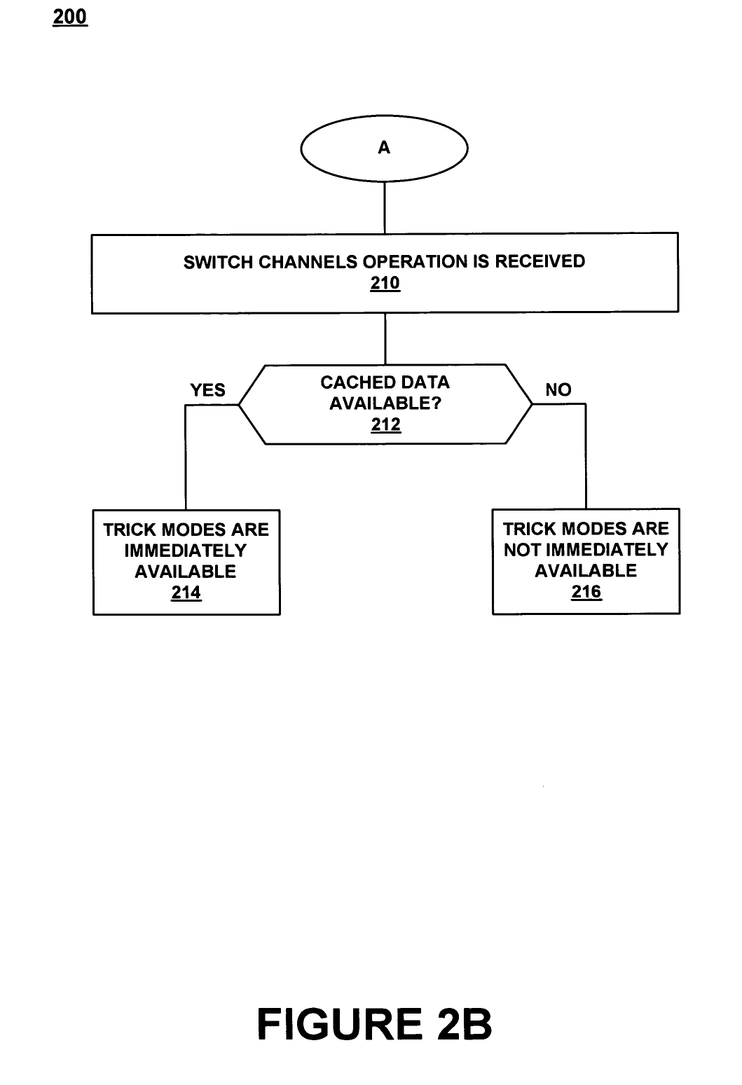

FIGS. 2A and 2B depict flowchart 200 for caching data from multiple channels simultaneously according to embodiments of the present invention. Although specific steps are disclosed in flowchart 200, such steps are exemplary. That is, embodiments of the present invention are well suited to performing various other steps or variations of the steps recited in flowchart 200. It is appreciated that the steps in flowchart 200 may be performed in an order different than presented, and that not all of the steps in flowchart 200 may be performed. All of, or a portion of, the embodiments described by flowchart 200 can be implemented using computer-readable and computer-executable instructions which reside, for example, in computer-usable media of a computer system or like device.

For the purposes of illustration, the discussion of flowchart 200 shall refer to the structures depicted in FIG. 1B.

In step 202 of FIG. 2A, data specifying a set of channels is received. For example, user 102 may use remote 110 and user interface 192 of favorites application 190 to enter data indicating that channels 152, 154, and 155 are user 102's favorite channels. Favorite channels may also be determined automatically by monitoring viewing habits of the TV watcher. The data indicating that channels 152, 154, and 155 are user 102's favorites may be stored in memory as a list of favorite channels 150B.

In step 204, data specifying a prioritization of the set of channels is received. For example, user 102 may also use remote 110 with user interface 192 to enter data indicating the order in which they like favorite channels 150B. As depicted in FIG. 1B, user 102 may enter a “1” for channel 154, thus, indicating that user 102 likes channel 154 best. Similarly, user 102 may enter a “2” for channel 155, thus, indicating that user 102 likes channel 155 second best, and so on. This prioritization data (e.g., “1”, “2”, etc.) may be stored in prioritization 160. Priority can also be determined based on viewing history.

In step 206, channels for which to cache data are selected from the set of channels based on the prioritization. For example, there may be a limited number of tuners for a given set-top box device. As depicted in FIG. 1B, set-top box device 130's pool of tuners 170 includes five tuners (171, 172, 173, 174, 175). In order for a person to watch or record a program, a tuner is assigned to a channel to receive data that represents the program the person wants to watch or record. The received data may be cached in caching device 180 as the data is received. Tuners not used for watching live broadcast are called “spare.”

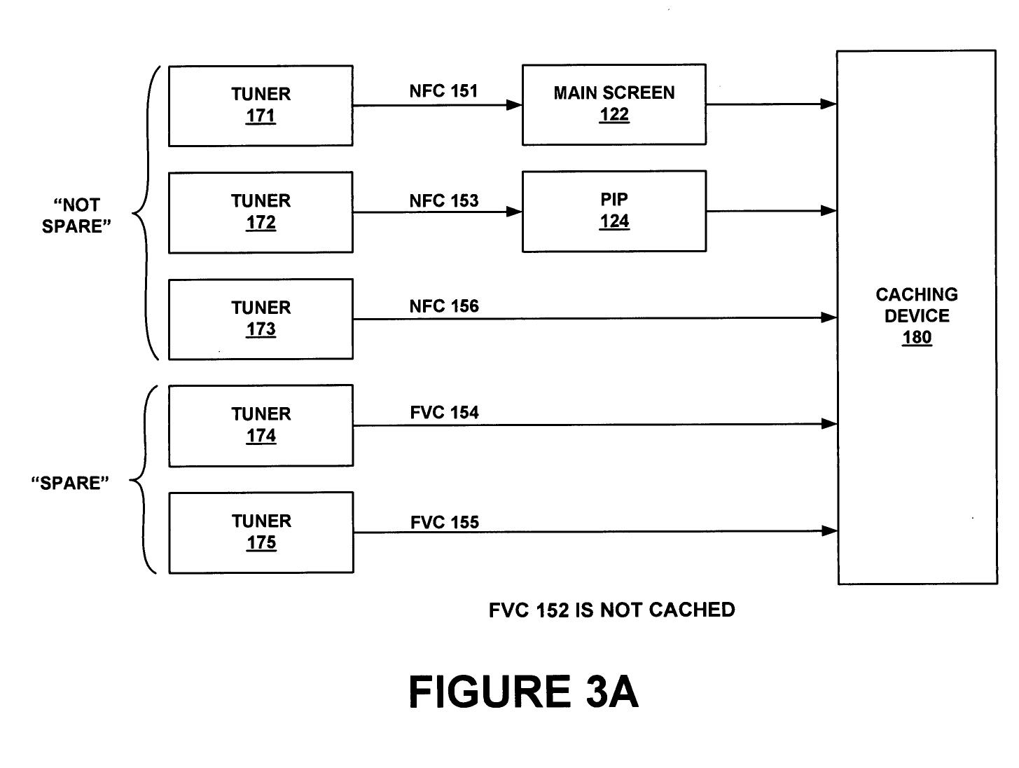

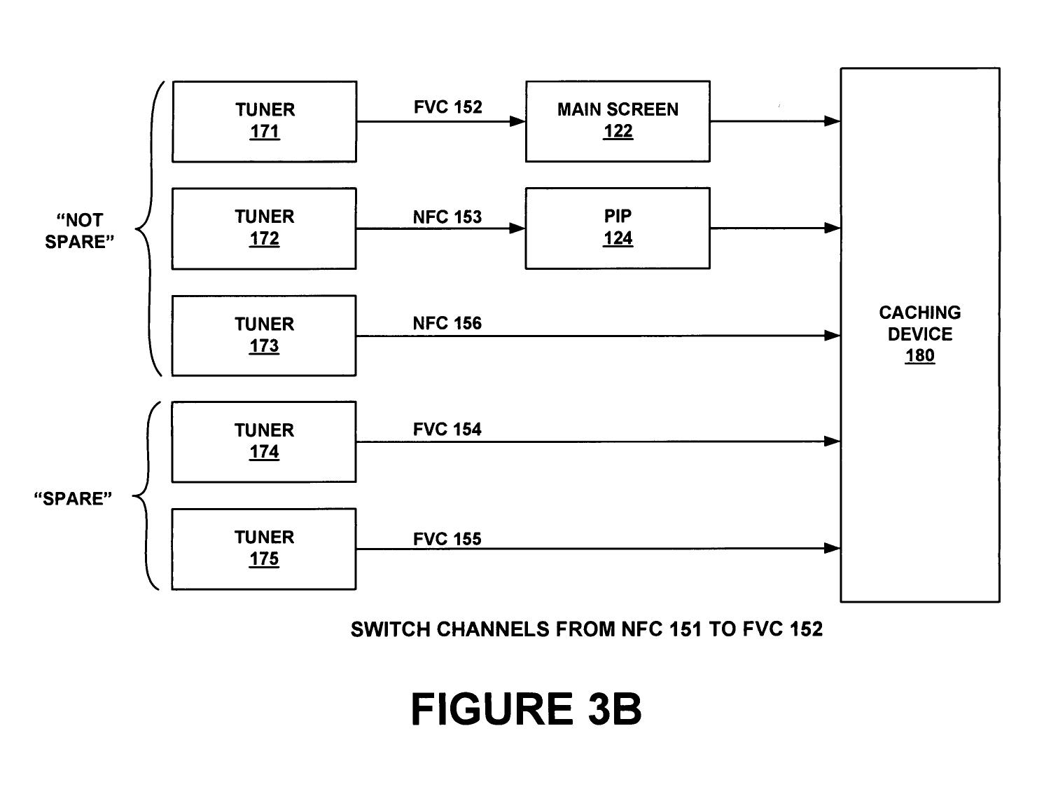

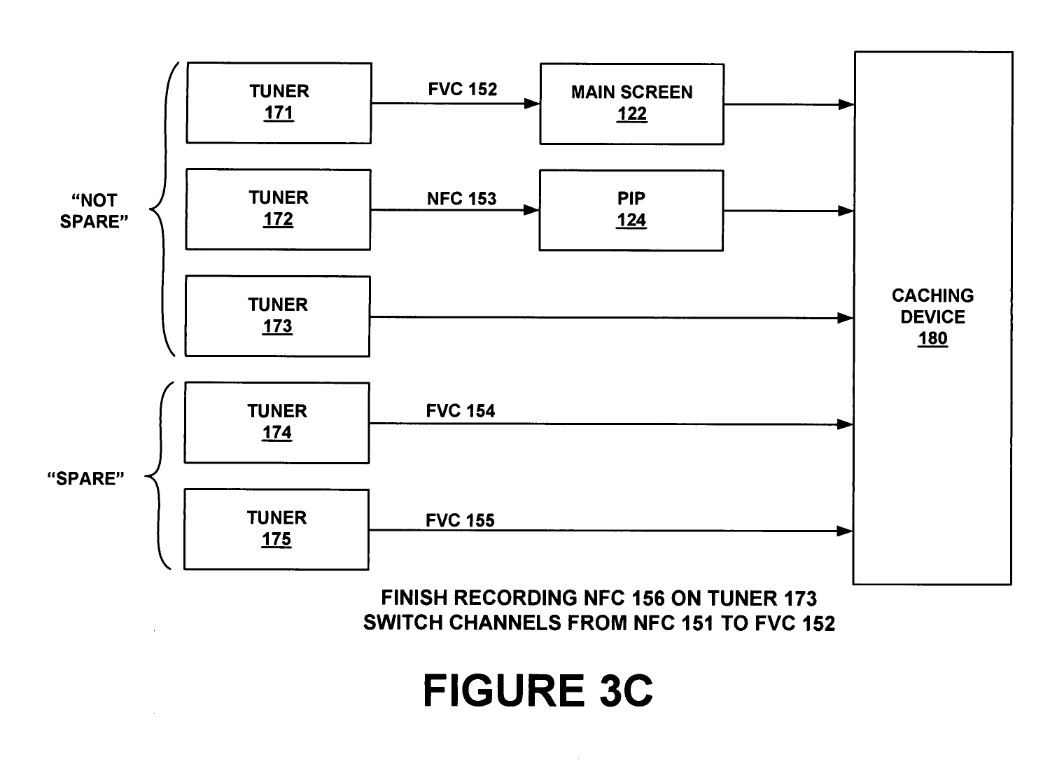

In one embodiment, available or “spare” tuners of the pool of tuners 170 are assigned to receive data for the favorite channels 150B based on the prioritization 160. For example, referring to FIG. 3A tuners 171 and 172 are currently assigned for watching programs for non-favorite channels 151 and 153 (“NFC” is an abbreviation for “non-favorite channel”). Tuner 173 is currently assigned to recording a program for non-favorite channel 156. Tuners 171, 172, 173 are “not spare” tuners because user 102 specifically requested to watch and/or record programs broadcast on the channels (151, 153, 156) to which the tuners 171, 172, 173 are assigned. Since user 102 has not requested to watch and/or record programs that would result in tuners 174 and 175 being assigned to channels, tuners 174 and 175 are currently available (“spare”) for receiving programs. In this case, tuners 174 and 175 may be assigned to favorite channels 154 and 155 (“FVC” is an abbreviation for “favorite channel”) respectively since channel 154 has the highest priority (e.g., “1”) and channel 155 has the second highest priority (e.g., “2”) of the favorite channels 150B. In one embodiment, there is an insufficient number of tuners to be assigned to all of the favorite channels. For example, as depicted in FIG. 3A, no tuner has been assigned to favorite channel 152 which has a lower priority (e.g., “3”) than favorite channels 154 and 155. Thus, data for favorite channel 152 is not cached.

In step 208, data for the selected channels is cached simultaneously. For example, referring to FIG. 3A, by assigning tuners (174, 175) to channels (154, 155) the data for the channels (154, 155) may be cached simultaneously in caching device 180. Specifically, a buffer x may be allocated in caching device 180 for caching data that represents a program A from channel 154 and a buffer y may be allocated in caching device 180 for caching data that represents a program B from channel 155; thus, data for channels (154, 155) may be cached simultaneously.

In step 210 of FIG. 2B, user 102 may desire to switch between channels in which case, cached data may or not be available (step 212) for the channel to which that user 102 switches. For example, cached data for a program A may not be available if user 102 just switched to the channel broadcasting program A. However, if user A has been watching and/or recording program A for awhile, cached data for program A is available.

In step 214, cached data is immediately available for the channel to which user 102 switches. Continuing the example, assume that programs A and B have been cached for awhile. The data cached in buffer x may allow user 102 to re-watch a portion of program A. Similarly, the data cached in buffer y may allow user 102 to re-watch a portion of program B. User 102 may switch between re-watching the portion of program A that is cached in buffer x and the portion of program B that is cached in buffer y.

In one embodiment, trick modes may be used for viewing cached data.

Continuing the example, user 102 may use rewind, pause, and fast-forward to select what portions of the cached data the user desires to re-watch. Specifically, if 30 minutes of data have been cached for program A at time T3, user 102 may rewind as far back as time T3−30 minutes and start re-watching a portion of program A. Similarly, user 102 may pause at and/or fast forward to any point within the 30 minutes of the program that proceeds time T3.

In one embodiment, a visual indicator may be used to indicate the amount of data that is cached for a particular channel when a viewer switches to that channel. For example, the visual indicator may be a progress bar that indicates the percentage of data cached in a buffer. For example, if the window size of the buffer is 30 minutes and 20 minutes of data is cached in the buffer for program A, then the progress bar may indicate that the circular buffer containing data for program A is 67% full (e.g., 20 minutes/30 minutes).

In step 216, cached data is not available for the channel to which user 102 switches. Referring to FIG. 3B, assume that user 102 switches from non-favorite channel 151, as depicted in FIG. 3A, to favorite channel 152, as depicted in FIG. 3B, so tuner 171 may be reassigned from channel 151 to channel 152 at time T4. At time T4 a buffer z may be allocated in the caching device 180 to cache data that represents a program C for channel 152. At time T4, the visual indicator would indicate that no data has been cached for program C and therefore trick modes are not available to rewind, pause, or fast forward through cached data for program C. However, as data is cached in buffer z, the visual indicator would indicate that data is available. For example at time T4+15 minutes, a progress bar may indicate that buffer z is 50% full and trick modes may be used to rewind, pause, and fast forward through the T4+15 minutes worth of cached data.

In one embodiment, all tuners are assigned to channels. For example, if the favorite channels all have tuners assigned to them, then any spare tuners may be assigned the most recently viewed non-favorite channels.

In another embodiment, not all tuners are assigned to channels. For example, referring to FIG. 3A, user 102 is watching non-favorite channel 151 which is being received in tuner 171 and is recording a program on non-favorite channel 156 which is being received on tuner 173. Now referring to FIG. 3C, assume that user 102 switches from watching non-favorite channel 151, as depicted in FIG. 3A, to favorite channel 152, as depicted in FIG. 3C, so tuner 171 is reassigned from channel 151 to channel 152. Also assume that whatever user 102 was recording on non-favorite channel 156 finishes so tuner 173 becomes available. In this case, tuners are assigned to all of the favorite channels (152, 154, 155) and tuner 173 is not assigned to any channel.

### Assigning Tuners to Channels

FIGS. 3A, 3B, and 3C are exemplary data flow diagrams for caching data from multiple channels simultaneously according to embodiments of the present invention. Tuners that the TV watcher has specifically requested to watch and/or record programs broadcast on channels are “not spare” tuners. Tuners that have not been assigned to channels due to a user's request are available (“spare”). In one embodiment, the “spare” tuners are assigned to favorite channels. For example, in FIG. 3A tuners 171, 172, 173 are not spare because a user specifically requested to watch programs on non-favorite channels 151, 153 and to record a program on non-favorite channel 153. However, tuners 174, 175 are spare and therefore are available to be assigned to favorite channels 154, 155. Similarly, referring to FIG. 3B, tuners 171, 172, 173 are not spare whereas tuners 174, 175 are spare and referring to FIG. 3C, tuners 171, 172 are not spare whereas tuners 173, 174, 175 are spare as already described herein.

### Switching Channels and Reassigning Cache Capabilities

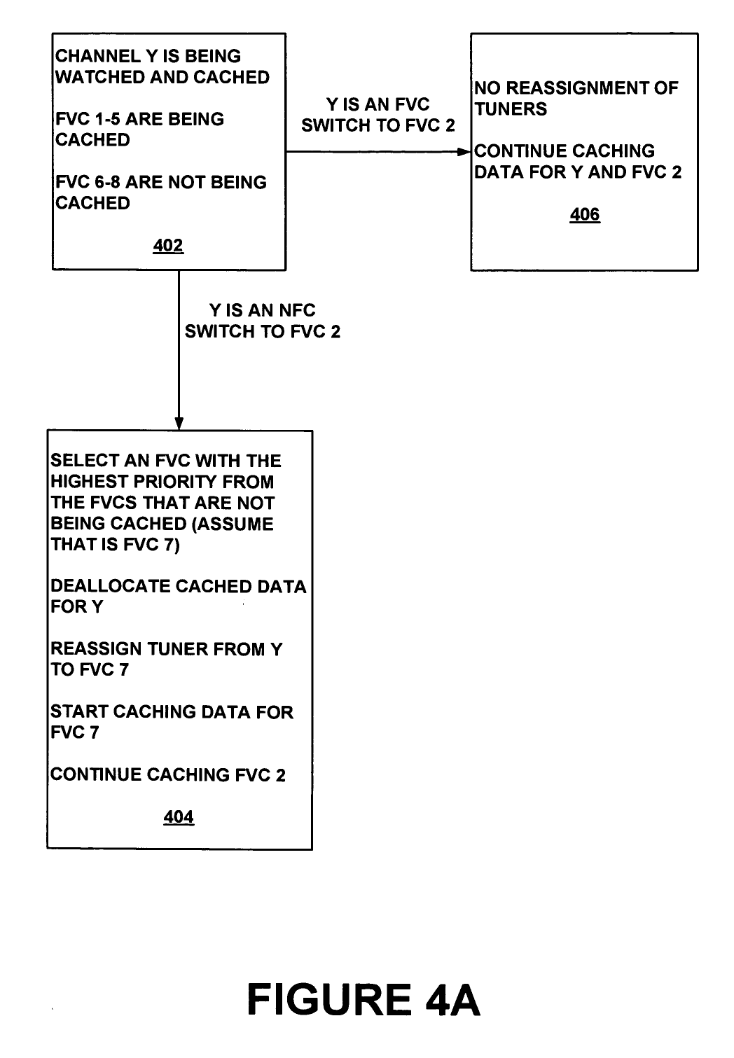

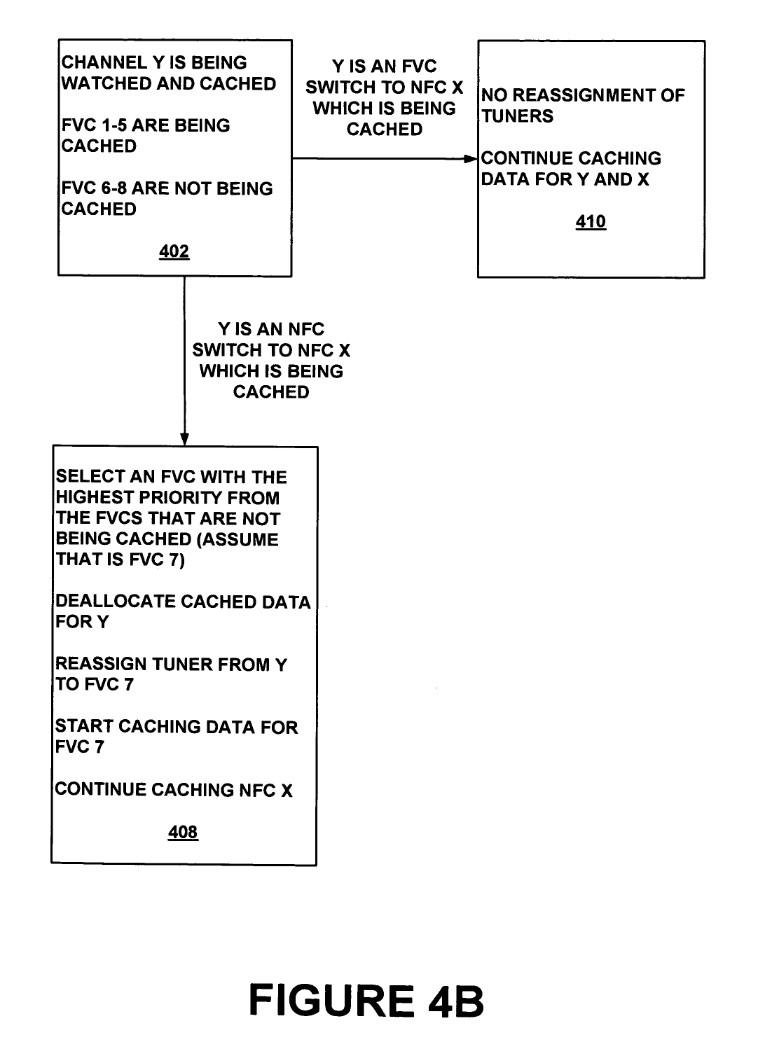

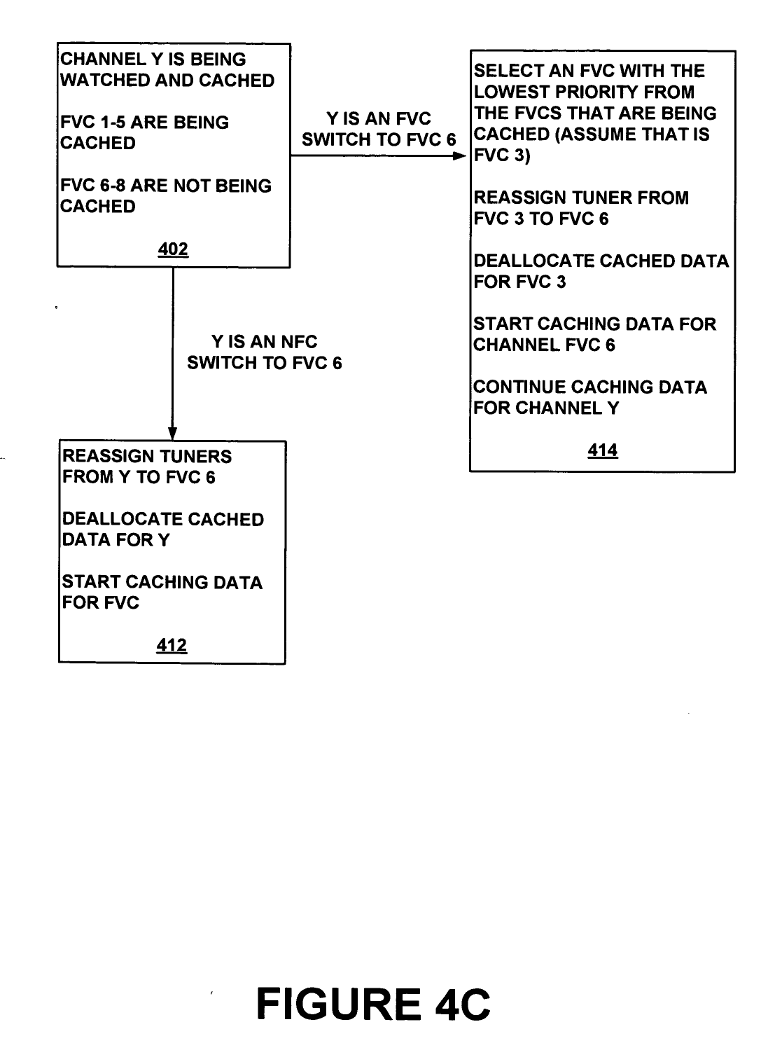

As a user is watching and/or recording programs from multiple channels, the user may decide they want to change the channels that they are watching and/or recording. For example, referring to box 402 of FIG. 4A assume that a pool of tuners includes six tuners that are all in use. One tuner is assigned to channel Y, which is being watched on a main screen 122. Similarly, favorite channels 1-5 are being recorded and cached. Favorite channels 6-8 are not being cached because all of the tuners are already assigned. In this case, caching device 180 may include six buffers accumulating data representing the programs that are being broadcast from the six channels (channel Y, and favorite channels 1-5).

Assume that user 102 initiates a “switch operation” to stop watching one channel and start watching another channel. In one embodiment, when caching capabilities of one channel become available, the caching capabilities are reassigned to the channel with the highest priority that is not currently being cached. For example, assume that user 102 switches from channel Y, which is a non-favorite channel, to favorite channel 2, which is being cached. In this case, the tuner that is assigned to non-favorite channel Y becomes available for reassignment. In box 404, a favorite channel with the highest priority is selected from the favorite channels that are not being cached. Assume that favorite channel 7 has the highest priority of favorite channels 6-8, which are not being cached. The tuner assigned to channel Y may be reassigned to favorite channel 7, thus, the “caching capability” of channel Y may be reassigned to channel 7.

In one embodiment, the data cached for one channel is de-allocated when a user switches from a channel for which data is being cached to a channel for which data is not being cached. In one embodiment, the data cached for a non-favorite channel is de-allocated when a user switches from the non-favorite channel to another channel. Continuing the example in box 404, the data cached for channel Y may be de-allocated. The data that represents the program that is being received on channel 7 may start to be cached in caching device 180 and the data that represents the program received on favorite channel 2 may continue to be cached.

In one embodiment, data that is being cached is not de-allocated when a user switches from one channel for which data is being cached to another channel for which data is also being cached. In one embodiment, the first channel is a favorite channel. For example, assume that channel Y is a favorite channel instead of a non-favorite channel and further assume that user 102 switches from favorite channel Y, which is being cached, to favorite channel 2, which is being cached. Continuing the example, in box 406 the tuner that is assigned to favorite channel Y does not become available for reassignment. Instead, the data that represents the programs that are received for favorite channels Y and 2 may continue to be cached.

Referring to FIG. 4B assume the pool of tuners includes seven tuners that are assigned to channels Y, FVC 1-5, and NFC X. Further, assume that channel Y is a non-favorite channel and that user 102 switches from channel Y to a non-favorite channel X, that is being cached. In this case, the logic depicted in box 408 is analogous to the logic depicted in box 404 except that box 408 refers to channel X where box 404 refers to channel FVC 2.

Still referring to FIG. 4B, now assume that channel Y is a favorite channel instead of a non-favorite channel and further assume that user 102 switches from the favorite channel Y to non-favorite channel X, which is being cached. In this case, the logic depicted in box 410 is analogous to the logic depicted in box 406 except that box 410 refers to channel X where box 406 refers to channel FVC 2.

As already stated, in one embodiment, the data cached for one channel is de-allocated when a user switches from a channel for which data is being cached to a channel for which data is not being cached. Further, the data cached for a non-favorite channel may be de-allocated when a user switches from the non-favorite channel to another channel. For example, referring to FIG. 4C, assume the pool of tuners includes six tuners that are assigned to channels Y, and FVC 1-5. Further, assume that user 102 switches from channel Y, which is a non-favorite channel to favorite channel 6. Referring to box 412, in this case, the tuner assigned to non-favorite channel Y may be reassigned to favorite channel 6, the data that represents the program that is being received on channel Y may be de-allocated, and the data that represents the program that is being received on channel 6 may start to be cached in caching device 180.

Assume that channel Y is a favorite channel instead of a non-favorite channel and further assume that user 102 switches from favorite channel Y to favorite channel 6, which is not being cached. Since user 102 switched to a favorite channel 6 that is not being cached, a tuner needs to be assigned to channel 6. Referring to box 414, in one embodiment, the cache capability of a channel with the lowest priority is reassigned to another channel. For example, assume that favorite channel 3 has the lowest priority of the favorite channels (FVC 1-5 and channel Y) that are being cached. In this case, the tuner assigned to favorite channel 3 is reassigned to favorite channel 6, thus, the caching capability of favorite channel 3 is reassigned to favorite channel 6. The data that represents the program that is being received on favorite channel 3 may be de-allocated, and the cached data that represents a portion of the program that is being received on favorite channel 6 may start to be cached in caching device 180. The data that represents the program received on favorite channel Y may continue to be cached.

### Hardware Overview

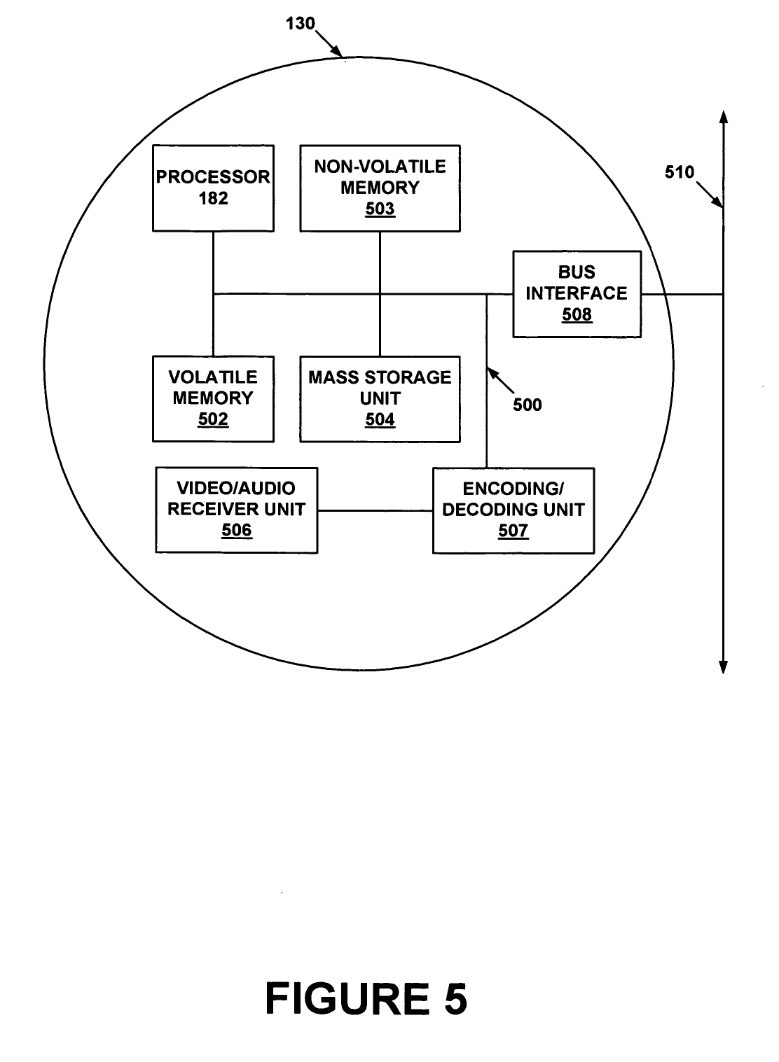

FIG. 5 illustrates an exemplary set-top box device upon which embodiments of the present invention may be practiced. Although a variety of different systems can be used in accordance with the present invention, an exemplary system is represented by set-top box device 130. In the present embodiment, set-top box device 130 is used to execute the program instructions for caching data from multiple channels simultaneously in accordance with the present invention. For example, set-top box device 130 may execute program instructions that implement the steps depicted in flowchart 200.

With reference to FIG. 5, in the present embodiment, set-top box device 130 includes processor 501 coupled with an internal address/data bus 500 for processing information and instructions. Volatile memory 502 (e.g., random access memory), for storing information and instructions for processor 182, is also coupled to bus 500. Non-volatile memory 503 (e.g., read only memory), for storing static information and instructions for processor 301, is coupled to bus 500. Set-top box device 130 optionally includes mass storage unit 504 (e.g., a data storage device such as a magnetic or optical disk and disk drive) coupled to bus 500 for storing information and instructions. Set-top box device 130 also includes video/audio receiver unit 506 and an encoding/decoding unit 507, such as a Moving Pictures Expert Group (MPEG) unit, coupled to bus 500. Bus interface 508 is used for interfacing with network bus 510.

### Conclusion

When tuners are assigned to channels, the data received for the channels may be cached even for channels that are not currently being watched or used for PIP. By allowing users to prioritize channels, the limited number of tuners may be assigned and re-assigned to the channels, thus, data may be cached simultaneously for the channels that users are most interested in.

### Extensions and Alternatives

Although certain embodiments of the present invention were described using a set-top box device, the present invention is not limited to the set-top box device described herein. Any mechanism that allows for simultaneously caching data from multiple channels may be used. For example, the techniques described herein may be implemented in a TV instead of a set-top box device.

Further, channels do not need to be designated as favorites. For example, all of the TV channels 150A may be prioritized and the priorities associated with the TV channels 150A may be used for assigning and reassigning tuners to the TV channels 150A.

In yet another example, the “non-favorite” channels may be thought of as having a default priority, such as “999”, that is lower than the priorities assigned to the “favorite” channels, thus, TV channels 150A do not necessarily need to be separated into “favorites” and “non-favorites”.

In yet another example, schedules may be associated with channels and the priorities assigned to the channels may be modified based on the schedules. For example, channel 154, which has a priority “1”, may be scheduled for recording on Tuesdays and channel 155, which has a priority of “2”, may be scheduled for recording on Wednesdays. In this case, the priority of channel 155 may be modified to “1” on Wednesdays.

Embodiments of the present invention are thus described. While the present invention has been described in particular embodiments, it should be appreciated that the present invention should not be construed as limited by such embodiments, but rather construed according to the following claims.

1. A method of caching data from multiple channels simultaneously, the method comprising:
accessing data specifying a set of channels;
accessing data specifying a prioritization of the set of channels;
selecting channels for which to cache data from the set of channels based on the prioritization; and
caching data for the selected channels simultaneously.

2. The method of claim 1, wherein the set of channels are favorite channels.

3. The method of claim 1, further comprising:
performing a video operation to allow viewing the cached data.

4. The method of claim 1, further comprising:
receiving a switch operation from a first channel for which data is being cached to a second channel for which data is not being cached; and
in response to receiving the switch operation, de-allocating the data for the first channel.

5. The method of claim 4, wherein the first channel is a non-favorite channel.

6. The method of claim 1, further comprising:
receiving a switch operation from a first channel to a second channel, wherein data is being cached for both the first and second channels; and
in response to receiving the switch operation, maintaining the data that is being cached for the first channel.

7. The method of claim 6, wherein the first channel is a favorite channel.

8. The method of claim 1, wherein in response to caching capabilities from a first channel becoming available:
selecting the channels further comprises selecting a second channel with the highest priority of the channels that are not being cached; and
caching the data further comprises using the caching capabilities from the first channel to cache the data for the second channel.

9. The method of claim 1, further comprising:
receiving a request to cache data for a first channel for which data is not being cached;
selecting a second channel with the lowest priority to remove caching capabilities from; and
reassigning the caching capabilities to the first channel to satisfy the request to cache data for the first channel.

10. An electronic device comprising:
a memory unit; and
a processor coupled to the memory unit, the processor for executing a method for caching data from multiple channels simultaneously, the method comprising:
accessing data specifying a set of channels;
accessing data specifying a prioritization of the set of channels;
selecting channels for which to cache data from the set of channels based on the prioritization;
selecting channels for which to cache data from channels selected for viewing; and
caching data for the selected channels simultaneously.

11. The electronic device of claim 10, wherein the method further comprises:
receiving a switch operation from a first channel for which data is being cached to a second channel for which data is not being cached; and
in response to receiving the switch operation, de-allocating the data for the first channel.

12. The electronic device of claim 10, wherein the method further comprises:
receiving a switch operation from a first channel to a second channel, wherein data is being cached for both the first and second channels; and
in response to receiving the switch operation, maintaining the data that is being cached for the first channel.

13. The electronic device of claim 10, wherein in response to caching capabilities from a first channel becoming available:
selecting the channels further comprises selecting a second channel with the highest priority of the channels that are not being cached; and
caching the data further comprises using the caching capabilities from the first channel to cache the data for the second channel.

14. The electronic device of claim 10, wherein the method further comprises:
receiving a request to cache data for a first channel for which data is not being cached;
selecting a second channel with the lowest priority to remove caching capabilities from; and
reassigning the caching capabilities to the first channel to satisfy the request to cache data for the first channel.

15. The electronic device of claim 10, wherein the electronic device is a set-top box device and wherein the set of channels are favorite channels.

16. An electronic device comprising:
a plurality of tuners;
a memory storage device coupled to said plurality of tuners;
a memory-stored list of channels having a channel ordering; and
a processor for selecting a first set of channels in response to viewing requests and for assigning a first set of tuners thereto,
wherein said processor is also for selecting a second set of channels based on said list of channels and for assigning a second set of tuners thereto,
wherein said memory storage device simultaneously caches outputs of said first and second set of tuners.

17. An electronic device as described in claim 16 wherein said list of channels is a favorite channels list and wherein said channel ordering is a priority ordering of said favorite channels list.

18. An electronic device as described in claim 17 further comprising a remote data entry device and wherein said favorite channels list and said channel ordering are obtained from said remote data entry device.

19. An electronic device as described in claim 16 wherein said plurality of tuners is also for providing picture-in-picture capabilities for output to a display device and wherein further said first set of channels comprise:
a first channel selected for viewing on a main screen of said display device; and
a second channel selected for viewing as a picture-in-picture window on said display device.

20. An electronic device as described in claim 16 wherein said processor is also for altering said first and second set of channels in response to a channel change request regarding a channel to be viewed.

21. An electronic device as described in claim 16 wherein said processor alters said second set of channels in response to a change in said channel ordering.

22. An electronic device as described in claim 21 wherein said list of channels is a favorite channels list and wherein said channel ordering is a priority ordering of said favorite channels list.

23. An electronic device as described in claim 22 wherein said plurality of tuners is also for providing picture-in-picture capabilities for output to a display device.
